(19) United States
(12) Patent Application Publication
(10) Pub. No.: US 2021/0132786 A1
(43) Pub. Date: May 6, 2021

(54) INFORMATION PROCESSING DEVICE AND CONTROL METHOD

(71) Applicant: LENOVO (SINGAPORE) PTE. LTD., SINGAPORE (SG)

(72) Inventors: Yoshitsugu Suzuki, YOKOHAMA (JP); Seiichi Kawano, YOKOHAMA (JP); Ryohta Nomura, YOKOHAMA (JP); Mitsuhiro Yamazaki, YOKOHAMA (JP)

(73) Assignee: LENOVO (SINGAPORE) PTE. LTD., SINGAPORE (SG)

(21) Appl. No.: 16/743,165

(22) Filed: Jan. 15, 2020

(30) Foreign Application Priority Data
Oct. 31, 2019 (JP) 2019198767

(51) Int. Cl. G06F 3/0488; G06F 3/0486; G06F 3/041; G06F 3/147

(52) U.S. Cl. CPC G06F 3/04883; G06F 3/147; G06F 3/0412; G06F 3/0486

(57) ABSTRACT

An information processing device includes an obtaining unit configured to obtain a result of detection by a first detection sensor that detects a first touch operation relative to a first panel and a result of detection by a second detection sensor that detects a second touch operation relative to a second panel; and an integration unit configured to integrate, based on the results of detection obtained by the obtaining unit, the result of detection of the first touch operation relative to the first panel and the result of detection of the second touch operation relative to the second panel as a result of detection of a touch operation relative to a panel resulting from integration of the first panel and the second panel into one panel.

### FIELD OF THE INVENTION

The present invention relates to an information processing device and a control method.

### BACKGROUND OF THE INVENTION

In recent years, information processing devices having a plurality of screens (for example, two screens) are available. For example, Japanese Unexamined Patent Application Publication No. 2015-233198 discloses an information processing device in which touch-panel displays adapted to touch operation with a finger or a pen are mounted on a first chassis and a second chassis, respectively, that are rotatable via a connection portion (a hinge mechanism).

### SUMMARY OF THE INVENTION

With such an information processing device, a user may wish to use the plurality of touch-panel displays with the same sense as that in using a single touch-panel display in some cases. In this case, it would be convenient if not only a plurality of displays that enable display so as to make a single screen but also a displayed user interface (UI) object (such as an icon) that freely moves across the plurality of displays in response to a drag operation or the like is available.

Unfortunately, as a touch sensor of each touch panel outputs touch information as a separate device, a drag operation across the boundary between touch panels is not recognized as a continuing drag operation, which is inconvenient.

The present invention has been conceived in view of the above, and it is one of the objects to provide an information processing device and a control method that improve operability relative to a plurality of touch panels.

The present invention has been conceived to achieve the above-described object, and an information processing device according to a first aspect of the present invention includes an obtaining unit configured to obtain a result of detection by a first detection sensor that detects a first touch operation relative to a first panel, and a result of detection by a second detection sensor that detects a second touch operation relative to a second panel; and an integration unit configured to integrate, based on the results of detection obtained by the obtaining unit, the result of detection of the first touch operation relative to the first panel and the result of detection of the second touch operation relative to the second panel as a result of detection of a touch operation relative to a panel resulting from integration of the first panel and the second panel into one panel.

In the above-described information processing device, in the case where the obtaining unit obtains a result of detection indicating that the first touch operation becomes no longer detected, and thereafter obtains a result of detection indicating that the second touch operation is newly detected, the integration unit may consider the first touch operation and the second touch operation as a series of successive touch operations, and integrate the first touch operation and the second touch operation.

In the above-described information processing device, the integration unit may consider the first touch operation and the second touch operation as a series of successive touch operations, based on the period of time from when the first touch operation becomes no longer detected to when the second touch operation is detected.

In the above-described information processing device, the integration unit may consider the first touch operation and the second touch operation as a series of successive touch operations in the case where the period of time from when the first touch operation becomes no longer detected to when the second touch operation is detected is less than a predetermined threshold, and the predetermined threshold may be determined, depending on the moving speed of the first touch operation.

In the above-described information processing device, the integration unit may consider the first touch operation and the second touch operation as a series of successive touch operations, based on the position on the first panel at the time when the first touch operation becomes no longer detected and the position on the second panel at the time when the second touch operation is detected.

In the above-described information processing device, the integration unit may consider the first touch operation and the second touch operation as a series of successive touch operations in the case where the position at the time when the first touch operation becomes no longer detected is in a first region on the first panel, and the position at the time when the second touch operation is detected is in a second region on the second panel, and in alignment for disposition of the first panel and the second panel, the first region may be set on the side of an edge of the peripheral edges of the first panel, the edge being on the side of the second panel, and the second region may be set on the side of an edge of the peripheral edges of the second panel, the edge being on the side of the first panel.

In the above-described information processing device, in the case where the second touch operation is newly detected when the position where the first touch operation is detected is in a first region on the first panel, the integration unit may consider the first touch operation and the second touch operation as a series of successive touch operations and integrate the first touch operation and the second touch operation when the position where the second touch operation is detected is in a second region on the second panel, and consider the first touch operation and the second touch operation as separate touch operations when the position where the second touch operation is detected is outside the second region, and in alignment for disposition of the first panel and the second panel, the first region may be set on the side of an edge of the peripheral edges of the first panel, the edge being on the side of the second panel, and the second region may be set on the side of an edge of the peripheral edges of the second panel, the edge being on the side of the first panel.

In the above-described information processing device, the second region may be set as a smaller region than the first region.

In the above-described information processing device, the integration unit may determine the position of the second region on the second panel, depending on the position on the first panel relevant to the first touch operation.

In the above-described information processing device, the integration unit may determine the dimension of the second region on the second panel, depending on the moving speed of the first touch operation.

In the above-described information processing device, the obtaining unit may obtain first identification information to identify the first touch operation as the result of detection by the first detection sensor, and obtain second identification information to identify the second touch operation as the result of detection by the second detection sensor, and the integration unit may convert the second identification information into the first identification information to thereby integrate the first touch operation and the second touch operation into a series of successive touch operations.

A control method for an information processing device according to a second aspect of the present invention includes the steps of obtaining by an obtaining unit, a result of detection by a first detection sensor that detects a first touch operation relative to a first panel, and a result of detection by a second detection sensor that detects a second touch operation relative to a second panel; and integrating by an integration unit, based on the results of detection obtained by the obtaining unit, the result of detection of the first touch operation relative to the first panel and the result of detection of the second touch operation relative to the second panel as a result of detection of a touch operation relative to a panel resulting from integration of the first panel and the second panel into one panel.

According to the above-described aspects of the present invention, it is possible to improve operability relative to a plurality of touch panels.

### BRIEF DESCRIPTION OF THE DRAWINGS

FIG. 1 is a perspective view illustrating the external appearance of an information processing device according to a first embodiment;

FIG. 2 is a diagram illustrating an example of a drag operation in the information processing device according to the first embodiment;

FIG. 3 is a block diagram illustrating an example of the structure of the information processing device according to the first embodiment;

FIG. 4 is a block diagram illustrating an example of the functional structure of a touch signal integration unit according to the first embodiment;

FIG. 5 is a diagram illustrating an example of detection of a drag operation according to the first embodiment;

FIG. 6 is a flowchart illustrating an example of touch signal integration processing according to the first embodiment;

FIG. 7 is a diagram illustrating an example of detection of a drag operation according to a second embodiment;

FIG. 8 is a flowchart illustrating an example of touch signal integration processing according to the second embodiment;

FIG. 9 is a diagram illustrating an example of the structure of an information processing system according to a third embodiment; and

FIG. 10 is a block diagram illustrating an example of the functional structure of a touch signal integration unit according to the third embodiment.

### DETAILED DESCRIPTION OF THE INVENTION

Embodiments of the present invention will now be described in detail with reference to the accompanying drawings.

### First Embodiment

Initially, an information processing device according to a first embodiment of the present invention will be outlined.

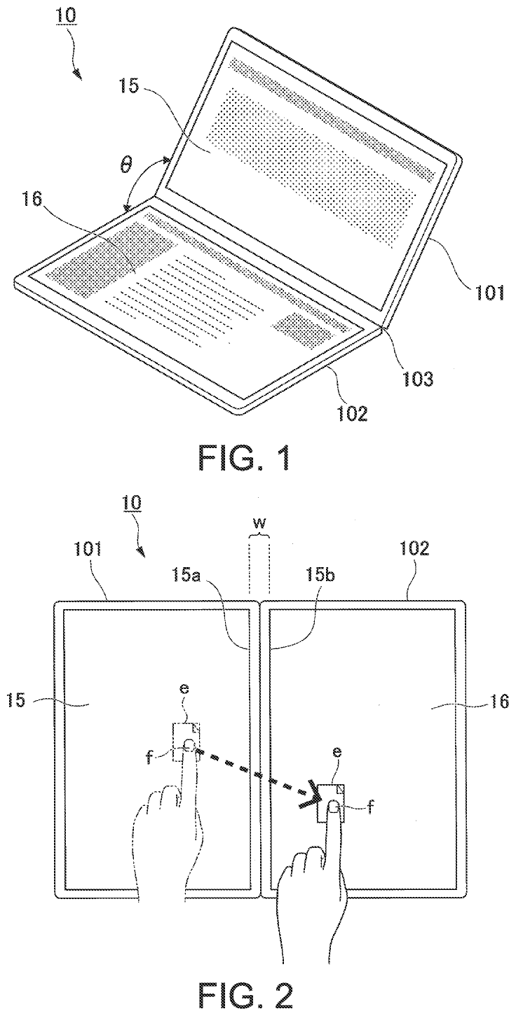

FIG. 1 is a perspective view illustrating the external appearance of an information processing device 10 according to this embodiment. The illustrated information processing device 10 is a clamshell-type (laptop-type) personal computer (PC) and can be used as a tablet-type PC.

The information processing device 10 includes a first chassis 101, a second chassis 102, and a hinge mechanism 103. Each of the first chassis 101 and the second chassis 102 is a chassis in a substantially quadrangular plate shape (for example, a plate shape). One of the side surfaces of the first chassis 101 is connected (linked) to one of the side surfaces of the second chassis 102 via the hinge mechanism 103, so that the first chassis 101 and the second chassis 102 are relatively rotatable around the rotation axis defined by the hinge mechanism 103. A state in which the open angle θ around the rotation axis of the first chassis 101 and the second chassis 102 is 0⁰ corresponds to a state (hereinafter referred to as a “closed state”) in which the first chassis 101 is placed on the second chassis 102 such that the first chassis 101 and the second chassis 102 are fully closed. The respective opposed surfaces of the first chassis 101 and the second chassis 102 in the closed state will be hereinafter referred to as “inside surfaces”, while the surfaces on the opposite side from the “inside surfaces” will be hereinafter referred to as “outside surfaces”. As opposed to the closed state, a state in which the first chassis 101 and the second chassis 102 are open is referred to as an “open state”. An “open state” is a state in which the first chassis 101 and the second chassis 102 are relatively rotated until the open angle θ (the angle defined by the inside surface of the first chassis 101 and the inside surface of the second chassis 102) becomes larger than a predetermined threshold (for example, 10°).

On each of the inside surface of the first chassis 101 and the inside surface of the second chassis 102, a touch-panel display is provided. Here, a touch-panel display provided on the inside surface of the first chassis 101, indicated by the symbol 15, is referred to as a “touch panel A”, while a touch-panel display provided on the inside surface of the second chassis 102, indicated by the symbol 16, is referred to as a “touch panel B”. Each of the touch panel A 15 and the touch panel B 16 includes a display unit whose display screen region corresponds to the region of the touch panel surface of the touch panel, and a touch sensor that detects a touch operation relative to the touch panel surface. The display unit includes, for example, a liquid crystal display or an organic electroluminescent (EL) display. The touch sensor can be a sensor adapted to any method, such as capacitance method or resistive film system.

When a user opens the information processing device 10 such that the information processing device 10 is in the open state, the user can visually check and operate the touch panel A 15 and the touch panel B 16, provided on the respective inside surfaces of the first chassis 101 and the second chassis 102. That is, the information processing device 10 is now ready to be used. Further, when the information processing device 10 is opened until the open angle θ defined by the first chassis 101 and the second chassis 102 becomes about 180°, the respective surfaces of the touch panel A 15 and the touch panel B 16 together define a substantially single plane. In this state, the information processing device 10 can be used like a tablet-type personal computer (PC) in a tablet mode in which the touch panel A 15 and the touch panel B 16 function as an integrated touch panel.

With the information processing device 10 including a plurality of touch panels, as described above, a user may wish to use the plurality of touch panels with the same sense as that in using a single touch panel. For example, in the above-mentioned tablet mode, the information processing device 10 controls display such that the display screens of the plurality of display units make a single integrated display screen, and also controls a displayed user interface (UI) object (such as an icon) such that the UI object freely moves across the plurality of touch panels (displays) in response to a drag operation, for example.

FIG. 2 illustrates one example of a drag operation with the information processing device 10. In the illustrated example, an icon e displayed on the touch panel A 15 is being moved to the touch panel B 16 with a drag operation. Specifically, touching the position of the icon e displayed on the touch panel A 15 with a finger f makes the icon e to be in a state of being selected (held). Then, the finger f is moved on the touch panel A 15 while touching the icon e toward the touch panel B 16. In response to the movement of the finger f, the position of the icon e is moved. When the finger f has moved across the right edge 15a (on the side of the touch panel B 16) of the touch panel A 15, the finger f enters the frame region around the touch panel A 15, and is thereby once removed from the touch panel A 15. Thereafter, the finger f is kept moving toward the touch panel B 16. The finger f is kept removed from the touch panel A 15 while moving in the distance w between the touch panel A 15 and the touch panel B 16. Once the finger f moves across the left edge 16a (on the side of the touch panel A 15) of the touch panel B 16, the finger f now touches the touch panel B 16. The information processing device 10 considers this touch operation relative to the touch panel B 16 as a continuation of the immediately preceding touch operation relative to the touch panel A 15 (a drag operation relative to the icon e), or a part of a series of successive touch operations (a drag operation), and moves the icon e selected (held) on the touch panel A 15 to the touch panel B 16 in response to the movement of the finger f to display the icon e on the touch panel B 16.

Although the touch operation with the finger f shifts from the touch panel A 15 to the touch panel B 16 during the drag operation from the touch panel A 15 to the touch panel B 16, as described above, the information processing device 10 considers the touch operation relative to the touch panel A 15 and the touch operation relative to the touch panel B 16 as a sequential continuous drag operation, and integrates these touch operations. With the above, the information processing device 10 enables free movement of a displayed icon, for example, across a plurality of touch panels (displays) with a drag operation.

(Structure of Information Processing Device 10)

The specific structure of the information processing device 10 will now be described.

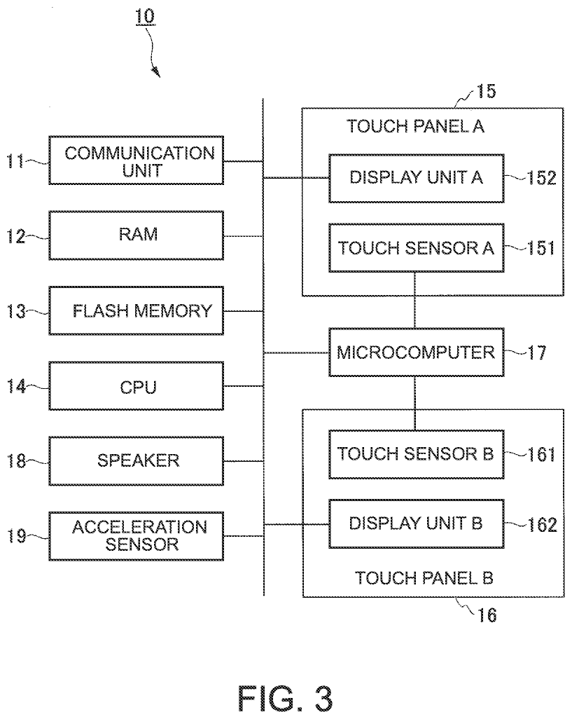

FIG. 3 is a block diagram illustrating one example of the structure of the information processing device 10 according to this embodiment. The information processing device 10 includes a communication unit 11, a random access memory (RAM) 12, a flash memory 13, a central processing unit (CPU) 14, the touch panel A 15, the touch panel B 16, a microcomputer 17, a speaker 18, and an acceleration sensor 19. These units are connected to one another via a bus, for example, so as to be able to communicate with one another.

The communication unit 11 includes, for example, digital input output ports, such as a plurality of Ethernet (registered trademark) ports or a plurality of Universal Serial Buses (USB), and a communication device for wireless communication, such as Bluetooth (registered trademark) or Wi-Fi (registered trademark).

A program and data for having the CPU 14 execute an operation, a control, or processing, for example, is developed in the RAM 12, and various data is arbitrarily stored or deleted. As the RAM 12 is a volatile memory, the data stored therein cannot be held once power supply is stopped.

The flash memory 13 is a non-volatile memory, such as a flash-read only memory (ROM). That is, the flash memory 13 can hold the data therein even if power supply thereto is stopped. For example, in the flash memory 13, a program and setting data for Basic Input Output System (BIOS), an operating system (OS), a program for an application operating on the OS, are stored.

The CPU 14 executes the BIOS, OS, or a program for various applications to thereby boot (activate) a system, such as the BIOS or OS, to execute various operations and processing. Also, the CPU 14 executes a memory control to read and write or delete data relative to the RAM 12, the flash memory 13, and so on. Note that the CPU 14 may include, either inside or outside the CPU 14, a structure, such as a graphic processing unit (GPU), to execute a specific operation and processing.

The touch panel A 15 (one example of a first panel) includes a touch sensor A 151 (one example of a first detection sensor) and a display unit A 152. The touch sensor A 151 is disposed overlying the display screen region of the display unit A 152, and detects a touch operation. That is, in actuality, a touch operation relative to the touch panel A 15 corresponds to a touch operation relative to the touch sensor A 151 disposed overlying the display screen region of the display unit A 152. The touch sensor A 151 detects a touch operation relative to the touch panel A 15 (the touch sensor A 151), and outputs a result of detection to the microcomputer 17.

The touch panel B 16 (an example of a second panel) includes a touch sensor B 161 (an example of a second detection sensor) and a display unit B 162. The touch sensor B 161 is disposed overlying the display screen region of the display unit B 162, and detects a touch operation. That is, in actuality, a touch operation relative to the touch panel B 16 corresponds to a touch operation relative to the touch sensor B 161 disposed overlying the display screen region of the display unit B 162. The touch sensor B 161 detects a touch operation relative to the touch panel B 16 (the touch sensor B 161), and outputs a result of detection to the microcomputer 17.

The microcomputer 17 is connected to the touch sensor A 151 and the touch sensor B 161 (for example, connected via a USB). The microcomputer 17 functions as a touch signal integration unit that obtains a result of detection by the touch sensor A 151 and a result of detection by the touch sensor B 161, and integrates the results of detection. For example, the microcomputer 17 includes a programmable microcomputer.

The speaker 18 outputs electronic bleeps or sounds, for example. The acceleration sensor 19 is provided, for example, inside each of the first chassis 101 and the second chassis 102, and detects the orientation and change in orientation of corresponding one of the first chassis 101 and the second chassis 102. The acceleration sensor 19 outputs a result of detection to the CPU 14. Based on the result of detection outputted from the acceleration sensor 19, the CPU 14 can detect the posture (orientation) of the information processing device 10 and the open angle θ defined by the first chassis 101 and the second chassis 102.

The functional structure of the touch signal integration unit of the microcomputer 17 will now be described.

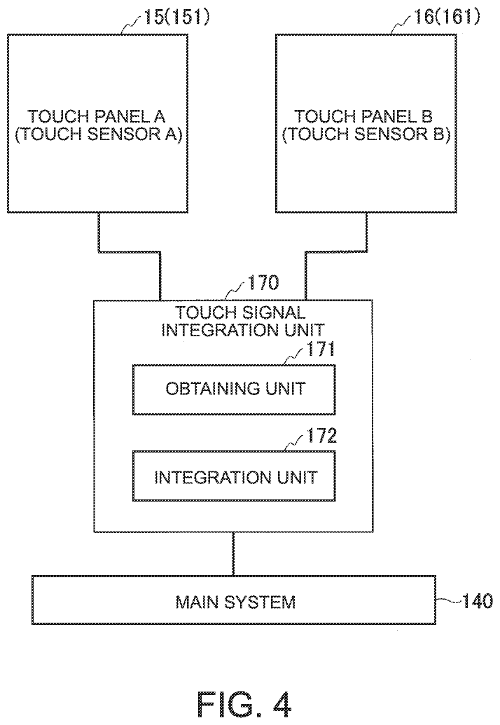

FIG. 4 is a block diagram illustrating one example of the functional structure of the touch signal integration unit according to this embodiment. The touch signal integration unit 170 illustrated separates the touch sensor A 151 and the touch sensor B 161 from the main system 140 so that a result of detection from the touch sensor A 151 and a result of detection from the touch sensor B 161 are not notified intact to the main system 140, and integrates the respective results of detection to notify the main system 140 of the integrated result. The main system 140 is a functional structure implemented by the OS executed by the CPU 14. With the above, the main system 140 can recognize a touch operation relative to the touch panel A 15 and a touch operation relative to the touch panel B 16 as a touch operation relative to a panel resulting from integration of the touch panel A 15 and the touch panel B 16 into a single panel, and execute a various kinds of processing.

For example, the touch signal integration unit 170 includes an obtaining unit 171 and an integration unit 172. The obtaining unit 171 obtains a result of detection from the touch sensor A 151 that detects a touch operation relative to the touch panel A 15 and a result of detection from the touch sensor B 161 that detects a touch operation relative to the touch panel B 16.

For example, the touch sensor A 151 and the touch sensor B 161 output respective touch signals in accordance with the respective touch operations relative to the touch panels as results of detection. A touch signal contains a touch ID, or identification information to identify each touch operation. A touch signal also contains flag information indicating whether a touch operation has been detected (for example, whether the touch panel has been touched with a finger or the finger has been removed from the touch panel). Here, in the case where the touch sensor A 151 and the touch sensor B 161 detect a touch operation (when being touched with a finger), the touch sensor A 151 and the touch sensor B 161 output a touch signal containing “Tip=1”, as flag information, associated with the touch ID. In contrast, in the case where the touch sensor A 151 and the touch sensor B 161 no longer detect a touch operation (when the finger has been removed), the touch sensor A 151 and the touch sensor B 161 output a touch signal containing “Tip=0”, as flag information, associated with the touch ID. A touch signal additionally contains operation position information (for example, coordinate information on a touch panel region (screen region)) indicating a position on the touch panel B 16 with a touch operation being detected.

Upon detection of a new touch operation (for example, when a touch panel is touched with a finger), each of the touch sensor A 151 and the touch sensor B 161 issues a touch ID. For example, upon detection of a new touch operation relative to the touch panel A 15, the touch sensor A 151 issues a touch ID (for example, “touch ID=0”), and outputs a touch signal containing the issued “touch ID=0”, “Tip=1”, and operation position information all being associated with one another. Subsequently, upon detection of a new touch operation relative to the touch panel A 15, the touch sensor A 151 issues a different touch ID (for example, “touch ID=1”) to discriminate from the initial touch operation, and outputs a touch signal containing the issued “touch ID=1”, “Tip=1”, and operation position information all being associated with one another. When the touch sensor A 151 comes to no longer detect the touch operation with “touch ID=0”, the touch sensor A 151 outputs a touch signal containing “touch ID=0”, “Tip=0”, and operation position information at the time when the touch operation becomes no longer detected (the last detected operation position information) all being associated with one another. The “touch ID=0” makes an ID that can be issued when a new touch operation is detected next.

Note that once the touch operation with “touch ID=0” becomes no longer detected, the touch sensor A 151 may output a touch signal containing “touch ID=0” and “Tip=0” being associated with each other and not containing operation position information. This is because the position at a time when a touch operation becomes no longer detected can be known also based on the immediately preceding touch signal.

Similarly, the touch sensor B 161 as well outputs a touch signal containing, for example, a touch ID, flag information (“Tip=1” or “Tip=0”), and operation position information, all being associated with one another, in response to a touch operation relative to the touch panel B 16. As the touch ID is individually issued by the touch sensor A 151 and the touch sensor B 161, a touch ID issued by the touch sensor A 151 is not particularly relevant to a touch ID issued by the touch sensor B 161. Hereinafter, in a case of discriminating between the touch ID of a touch operation detected by the touch sensor A 151 and the touch ID of a touch operation detected by the touch sensor B 161, the respective touch IDs will be referred to as a “first touch ID” (an example of first identification information) and a “second touch ID” (an example of second identification information).

The obtaining unit 171 obtains a touch signal outputted from the touch sensor A 151 as a result of detection by the touch sensor A 151. Specifically, the obtaining unit 171 obtains a touch signal containing, for example, a first touch ID, flag information indicating whether a touch operation has been detected, and operation position information, from the touch sensor A 151. In addition, the obtaining unit 171 obtains a touch signal outputted from the touch sensor B 161 as a result of detection by the touch sensor B 161. Specifically, the obtaining unit 171 obtains a touch signal containing, for example, a second touch ID, flag information indicating whether a touch operation has been detected, and operation position information, from the touch sensor B 161.

Based on the results of detection obtained by the obtaining unit 171, the integration unit 172 detects a touch operation relative to the touch panel A 15 (the first touch ID, flag information of “Tip=1” or “Tip=0”, and operation position information) and a touch operation relative to the touch panel B 16 (the second touch ID, flag information of “Tip=1” or “Tip=0”, and operation position information). For example, based on the results of detection obtained by the obtaining unit 171, the integration unit 172 integrates the result of detection of a touch operation relative to the touch panel A 15 and the result of detection of a touch operation relative to the touch panel B 16 as a result of detection of a touch operation relative to a touch panel resulting from integration of the touch panel A 15 and the touch panel B 16 into one touch panel. For example, in the case where the obtaining unit 171 obtains a result of detection indicating that the touch operation relative to the touch panel A 15 becomes no longer detected and thereafter obtains a result of detection indicating that a new touch operation relative to the touch panel B 16 is detected, the integration unit 172 considers the touch operation relative to the touch panel A 15 and the touch operation relative to the touch panel B 16 as a series of successive touch operations (that is, a drag operation), and integrates these touch operations.

For example, in the case where the period of time from when the touch operation relative to the touch panel A 15 becomes no longer detected to when a new touch operation relative to the touch panel B 16 is detected is less than a predetermined threshold, the integration unit 172 considers the touch operation relative to the touch panel A 15 and the touch operation relative to the touch panel B 16 as a series of successive touch operations (that is, a drag operation). Specifically, the integration unit 172 considers the touch operation relative to the touch panel A 15 and the touch operation relative to the touch panel B 16 from when the touch operation relative to the touch panel A 15 becomes no longer detected to when a new touch operation relative to the touch panel B 16 is detected as a series of successive touch operations (that is, a drag operation).

The integration unit 172 may determine the predetermined threshold, depending on the moving speed of a touch operation relative to the touch panel A 15. For example, the integration unit 172 may make the predetermined threshold smaller (or a shorter period of time) with respect to a faster moving speed of a touch operation relative to the touch panel A 15, and larger (a longer period of time) with respect to a slower moving speed.

Alternatively, based on the position on the touch panel A 15 when the touch operation relative to the touch panel A 15 becomes no longer detected and the position on the touch panel B 16 when a new touch operation relative to the touch panel B 16 is detected, the integration unit 172 may consider the touch operation relative to the touch panel A 15 and the touch operation relative to the touch panel B 16 as a series of successive touch operations (that is, a drag operation).

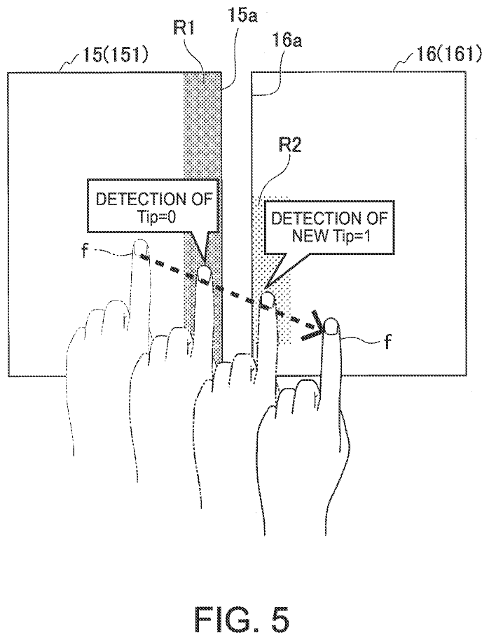

FIG. 5 illustrates an example of detection of a drag operation according to this embodiment. This drawing illustrates the touch panel A 15 (the touch sensor A 151) and the touch panel B 16 (the touch sensor B 161) when the information processing device 10 is in a tablet mode (for example, the open angle)θ=180° (refer to FIG. 2). As to the alignment for disposition of the touch panel A 15 and the touch panel B 16, in the drawing, the touch panel on the left side is the touch panel A 15, and one on the right side is the touch panel B 16. Here, an example of detection with a drag operation being made from the touch panel A 15 (a movement start) to the touch panel B 16 (a movement end) is illustrated.

The integration unit 172 sets a first region R1 as a detection region on the movement-start side on the side of the right edge 15a (on the side of the touch panel B 16) of the peripheral edges of the touch panel A 15, or the movement start of a drag operation. The first region R1 is a detection region for detecting a drag operation toward the touch panel B 16. Assume here that the first region R1 is set as a rectangular region having the edge 15a as one longer edge and a predetermined width (for example, about one to two centimeters). The position of the first region R1 does not change even when the position of a touch operation relative to the touch panel A 15 moves.

Meanwhile, the integration unit 172 sets a second region R2 as a detection region on the movement-end side on the side of the left edge 16a (the side of the touch panel A 15) of the peripheral edges of the touch panel B 16, or the movement end of the drag operation. The second region R2 is a detection region for detecting a drag operation having moved from the touch panel A 15. Assume here that the second region R2 is set as a rectangular region having at least a part of the edge 16a as one longer edge and a predetermined width (for example, about one to two centimeters). Note here that the length of the second region R2 in the longer edge direction may be the same as that of the edge 16a, or may be set shorter than that of the edge 16a in view of prevention of erroneous detection. That is, the second region R2 on the movement-end side may be set as a smaller region than the first region R1 on the movement-start side (in particular, the length in the direction of the edge 16a). The integration unit 172 may change the position of the second region R2 on the touch panel B 16, depending on the position of a touch operation relative to the touch panel A 15.

For example, when the position of a touch operation relative to the touch panel A 15 moves upward in the drawing, the integration unit 172 moves the position of the second region R2 upward, following the movement. Meanwhile, when the position of a touch operation relative to the touch panel A 15 moves downward in the drawing, the integration unit 172 moves downward the position of the second region R2 on the touch panel B 16, following the movement.

In the case where the position where the touch operation relative to the touch panel A 15 becomes no longer detected (that is, a position where “Tip=0” is detected) is in the first region R1 on the touch panel A 15, and the position where a touch operation relative to the touch panel B 16 is detected is in the second region R2 on the touch panel B 16, the integration unit 172 considers the touch operation relative to the touch panel A 15 and the touch operation relative to the touch panel B 16 as a series of successive touch operations (that is, a drag operation).

With the above, the information processing device 10 can prevent failure in detection of a drag operation having moved from the touch panel A 15, or the movement start, and also prevent erroneous detection of a new mere touch operation relative to the touch panel B 16, which is not a drag operation, as a drag operation having moved from the touch panel A 15.

Note that, the integration unit 172 may change the dimension of the second region R2 on the touch panel B 16, depending on the moving speed of the touch operation relative to the touch panel A 15, or the movement start. For example, the integration unit 172 may make larger the width of the second region R2 in the right-left direction with respect to a faster moving speed of a touch operation on the movement-start side, and smaller the width of the second region R2 in the right-left direction with respect to a slower moving speed.

Although an example of detection when a drag operation is made from the touch panel A 15 (the movement start) to the touch panel B 16 (the movement end) has been described above referring to FIG. 5, in the case where a drag operation is made from the touch panel B 16 (the movement start) to the touch panel A 15 (the movement end), the first region R1 is set on the touch panel B 16 as a detection region on the movement-start side, and the second region R2 is set on the touch panel A 15 as a detection region on the movement-end side. The timing at which the first region R1 and the second region R2 are set may be at a timing at which a new touch operation relative to either touch panel is detected or a timing at which, after detection of a new touch operation, a position where the new touch operation is detected is moved. With a touch panel adapted to multiple touches, or a touch panel that receives two or more touch operations at the same time, the first region R1 and the second region R2 may be set for every touch operation detected so that a plurality of first regions R1 and second regions R2 are resulted.

(Operation of Touch Signal Integration Processing)

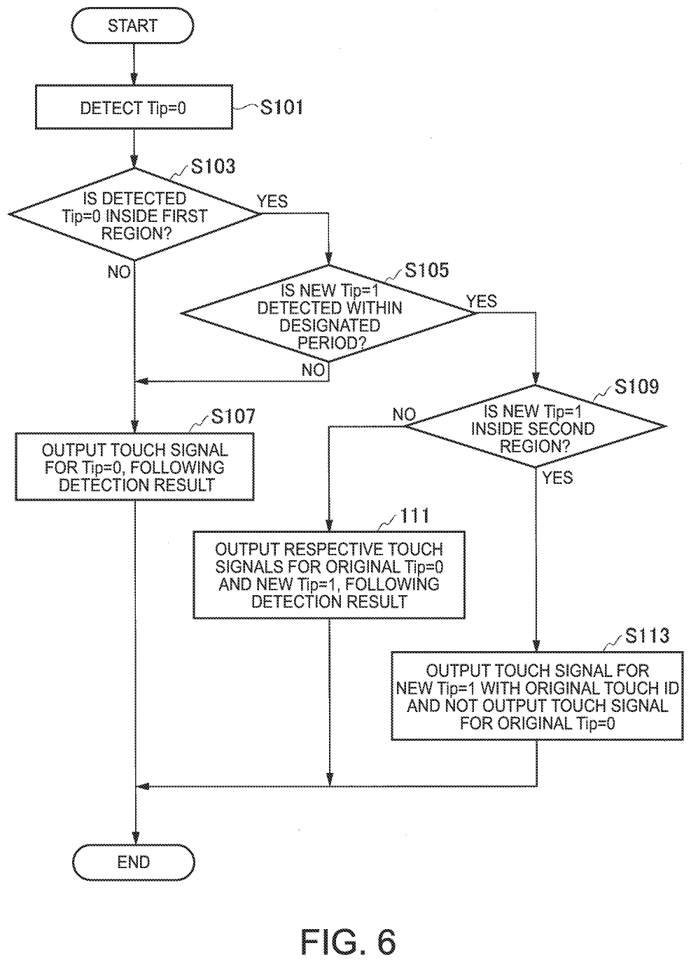

An operation of touch signal integration processing to be executed by the touch signal integration unit 170 will now be described. FIG. 6 is a flowchart illustrating one example of touch signal integration processing according to this embodiment.

(Step S101) The touch signal integration unit 170 detects “Tip=0” (that is, a touch operation becomes no longer detected), based on the results of detection obtained from the touch sensor A 151 and the touch sensor B 161, and then proceeds to the processing at step S103.

(Step S103) The touch signal integration unit 170 determines, based on the touch ID and operation position information associated with the detected “Tip=0”, whether the position relevant to the detected “Tip=0” is within the first region R1. When it is determined that the position is not in the first region R1 (NO), the touch signal integration unit 170 proceeds to the processing at step S107. Meanwhile, when it is determined that the position is in the first region R1 (YES), the touch signal integration unit 170 proceeds to the processing at S105.

(Step S105) The touch signal integration unit 170 determines whether new “Tip=1” (that is, a new touch operation) has been detected within a designated period of time. For example, in the case where the period of time from detection of “Tip=0” to detection of new “Tip=1” is less than a predetermined threshold, the touch signal integration unit 170 determines that new “Tip=1” has been detected within a designated period of time. In the case where it is determined that new “Tip=1” has been detected within the designated period of time (YES), the touch signal integration unit 170 proceeds to the processing at step S109. Meanwhile, in the case where the period of time from detection of “Tip=0” to detection of new “Tip=1” is equal to or greater than a predetermined threshold, the touch signal integration unit 170 determines that new “Tip=1” has not been detected within the designated period of time. In the case where it is determined that new “Tip=1” has not been detected within the designated period of time (NO), the touch signal integration unit 170 proceeds to the processing at step S107.

(Step S107) Following the result of detection, the touch signal integration unit 170 outputs a touch signal containing the touch ID and operation position information associated with the detected “Tip=0” to the main system 140. That is, the touch signal integration unit 170 notifies the main system 140 of a touch signal indicating the end of the touch operation (for example, the finger is removed).

(Step S109) Based on the touch ID and operation position information associated with the newly detected “Tip=1”, the touch signal integration unit 170 determines whether the position relevant to the detected “Tip=1” is inside the second region R2. When it is determined that the position is outside the second region R2 (NO), the touch signal integration unit 170 proceeds to the processing at step S111. Meanwhile, when it is determined that the position is inside the second region R2 (YES), the touch signal integration unit 170 proceeds to the processing at step S113.

(Step S111) Following the result of detection, the touch signal integration unit 170 outputs a touch signal containing the touch ID and operation position information associated with the original “Tip=0” and a touch signal containing the touch ID and operation position information associated with the new “Tip=1” to the main system 140. That is, the touch signal integration unit 170 determines that the touch signal indicating the end of the touch operation (for example, the finger is removed) and the touch signal indicating a new touch operation are touch signals indicating different touch operations, and notifies the main system 140 of the respective touch signals. In the above, if the touch ID associated with the new “Tip=1” is the same as the touch ID associated with the original “Tip=0”, the touch signal integration unit 170 converts the former touch ID into a different touch ID to output the resultant touch ID as a touch signal indicating a different touch operation.

(Step S113) The touch signal integration unit 170 does not output a touch signal containing the touch ID and operation position information associated with the original (movement start) “Tip=0”, but outputs a touch signal relevant to the new “Tip=1”, using the original (movement start) touch ID, to the main system 140. Specifically, the touch signal integration unit 170 outputs a touch signal to the main system 140, the touch signal containing the operation position information associated with the new “Tip=1” and the touch ID associated with the original “Tip=0”, instead of the touch ID associated with the new “Tip=1”. With the above, the touch signal integration unit 170 can integrate the touch signal relevant to the original (movement start) “Tip=0” and the touch signal relevant to the new “Tip=1” as a touch signal indicating a series of successive touch operations (that is, a drag operation), and output the integrated touch signal.

As described above, the information processing device 10 according to this embodiment obtains a result of detection by the touch sensor A 151 that detects a touch operation relative to the touch panel A 15, and a result of detection by the touch sensor B 161 that detects a touch operation relative to the touch panel B 16. Then, based on the obtained results of detection, the information processing device 10 integrates the result of detection of the touch operation relative to the touch panel A 15 and the result of detection of the touch operation relative to the touch panel B 16 as a result of detection of a touch operation relative to a panel resulting from integration of the touch panel A 15 and the touch panel B 16 into a single panel.

With the above, as the information processing device 10 detects touch operations relative to a plurality of touch panels as a touch operation relative to a touch panel resulting from integration of the plurality of touch panels into a single panel, it is possible to improve the operability relative to the plurality of touch panels.

For example, in the case where the obtaining unit 171 obtains a result of detection indicating that the first touch operation relative to the touch panel A 15 is no longer detected, and thereafter obtains a result of detection indicating that a new second touch operation relative to the touch panel B 16 is detected, the information processing device 10 considers the first touch operation and the second touch operation as a series of successive touch operations, and integrates these touch operations.

With the above, since the information processing device 10 considers the touch operations having moved from the touch panel A 15 to the touch panel B 16 as a series of touch operations and integrates the touch operations, it is possible to recognize a drag operation across a plurality of touch panels, to thereby improve the operability.

As one example, the information processing device 10 considers the first touch operation and the second touch operation as a series of successive touch operations, based on the period of time from when the first touch operation becomes no longer detected to when the second touch operation is detected. Specifically, in the case where the period of time from when the first touch operation becomes no longer detected to when the second touch operation is detected is less than a predetermined threshold, the information processing device 10 considers the first touch operation and the second touch operation as a series of successive touch operations.

With the above, since the information processing device 10 considers the two touch operations as a series of touch operations, based on the time interval from when the touch on the touch panel A 15 is released to when the touch panel B 16 is touched (for example, when the time interval is short), it is possible to improve the accuracy in recognition of a drag operation across the plurality of touch panels.

Note that the information processing device 10 may determine the predetermined threshold, depending on the moving speed of the first touch operation.

With the above, the information processing device can improve the accuracy in recognition of a drag operation across a plurality of touch panels in respective cases where the moving speed of a drag operation is fast and slow.

In addition, the information processing device 10 considers the first touch operation and the second touch operation as a series of successive touch operations, based on the position on the touch panel A 15 when the first touch operation becomes no longer detected and the position on the touch panel B 16 when the second touch operation is detected.

With the above, in the case where continuity between the position where the touch on the touch panel A 15 is released and the position where the touch panel B 16 is touched is low, the information processing device 10 can avoid considering these touch operations as a series of successive touch operations, which can improve the accuracy in recognition of a drag operation across the plurality of touch panels.

For example, in the case where the position where the first touch operation becomes no longer detected is in the first region R1 on the touch panel A 15 and the position where the second touch operation is detected is in the second region R2 on the touch panel B 16, the information processing device 10 considers the first touch operation and the second touch operation as a series of successive touch operations. Note here that, in alignment for disposition of the touch panel A 15 and the touch panel B 16, the first region R1 is set on the side of an edge of the peripheral edges of the touch panel A 15, the edge being on the side of the touch panel B 16, and the second region R2 is set on the side of an edge of the peripheral edges of the touch panel B 16, the edge being on the side of the touch panel A 15.

With the above, as the information processing device 10 considers two touch operations as a series of successive touch operation in the case where the direction from the position where the touch on the touch panel A 15 is released to the position where the touch panel B 16 is touched corresponds to the direction from the touch panel A 15 to the touch panel B 16, it is possible to improve the accuracy in recognition of a drag operation across the plurality of touch panels.

For example, the second region R2 is set as a smaller region than the first region R1.

With the above, as the information processing device 10 can more accurately determine whether the direction from the position where the touch on the touch panel A 15 is released to the position where the touch panel B 16 is touched corresponds to the direction from the touch panel A 15 to the touch panel B 16, it is possible to improve the accuracy in recognition of a drag operation across the plurality of touch panels.

In addition, the information processing device 10 determines the position of the second region R2 on the touch panel B 16, depending on the position of the first touch operation on the touch panel A 15.

With the above, as the information processing device 10 can more accurately determine whether the direction from the position where the touch on the touch panel A 15 is released to the position where the touch panel B 16 is touched corresponds to the direction from the touch panel A 15 to the touch panel B 16, it is possible to improve the accuracy in recognition of a drag operation across the plurality of touch panels.

Note that the information processing device 10 may determine the dimension of the second region on the touch panel B 16, depending on the moving speed of the first touch operation.

With the above, the information processing device can improve the accuracy in recognition of a drag operation across a plurality of touch panels in respective cases where the moving speed of a drag operation is fast and slow.

In addition, the information processing device 10 obtains information containing the first touch ID (an example of the first identification information) to identify the first touch operation as a result of detection by the touch sensor A 151. Further, the information processing device 10 obtains information containing the second touch ID (an example of the second identification information) to identify the second touch operation as a result of detection by the touch sensor B 161. Then, the information processing device 10 converts the second touch ID into the first touch ID to thereby integrate the first touch operation and the second touch operation into a series of successive touch operations.

With the above, the information processing device 10 can integrate the touch operations having moved from the touch panel A 15 to the touch panel B 16 as a series of same touch operations.

### Second Embodiment

A second embodiment of the present invention will now be described.

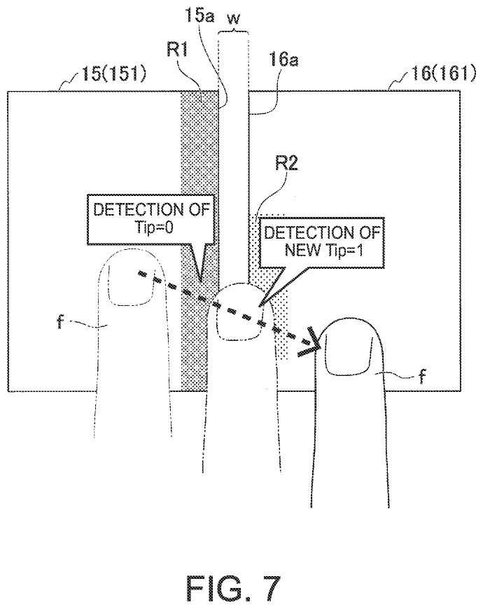

FIG. 7 illustrates an example of detection of a drag operation according to this embodiment. As illustrated, in the case where the distance w between the touch panel A 15 (the touch sensor A 151) and the touch panel B 16 (the touch sensor B 161) is short, it may happen that both the touch panels are touched with a single finger f. In this case, both the touch sensor A 151 and the touch sensor B 161 simultaneously detect “Tip=1”. That is, although this is a touch operation with a single finger, as the touch sensor A 151 and the touch sensor B 161 respectively output touch signals, the main system 140 can erroneously determine that two kinds of separate touch operations have been made. To address the above, in this embodiment, a structure for avoiding erroneous detection due to touch on both touch panels with a single finger f will be described.

In the case where a new touch operation relative to the touch panel B 16 is detected when the position where the touch operation relative to the touch panel A 15 is detected is inside the first region R1 on the touch panel A 15, the integration unit 172 determines whether the touch operation relative to the touch panel A 15 and the new touch operation are the same touch operation or different touch operations, based on whether the position where the new touch operation is detected is in the second region R2 on the touch panel B 16. In the case where it is determined that the position where the new touch operation is detected is inside the second region R2 on the touch panel B 16, the integration unit 172 considers the touch operation relative to the touch panel A 15 and the new touch operation as a series of successive touch operations (that is, a drag operation made through the same touch operation), and integrates these operations. Meanwhile, in the case where it is determined that the position where the new touch operation is detected is outside the second region R2, the integration unit 172 considers that the touch operation relative to the touch panel A 15 and the new touch operation are different touch operations (that is, these operations are not integrated but handled as separate touch operations).

(Operation of Touch Signal Integration Processing)

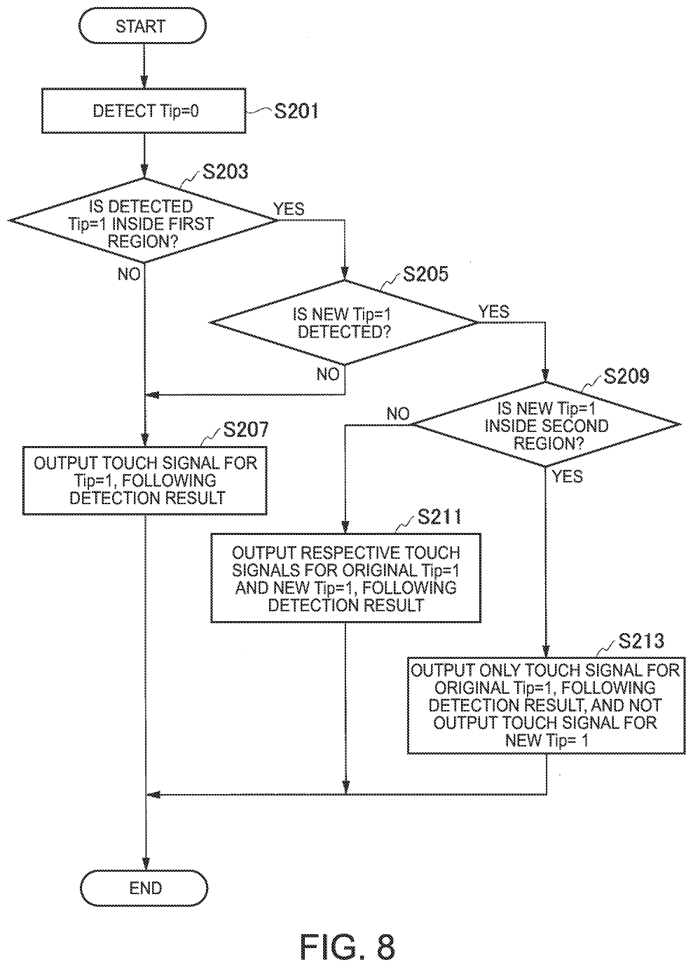

FIG. 8 is a flowchart illustrating one example of touch signal integration processing according to this embodiment.

(Step S201) When the touch signal integration unit 170 detects “Tip=1” (that is, detection of a touch operation), based on the results of detection obtained from the touch sensor A 151 and the touch sensor B 161, the touch signal integration unit 170 proceeds to the processing at step S203.

(Step S203) Based on the touch ID and operation position information associated with the detected “Tip=1”, the touch signal integration unit 170 determines whether the position relevant to the detected “Tip=1” is inside the first region R1. When it is determined that the position is not inside the first region R1 (NO), the touch signal integration unit 170 proceeds to the processing at step S207. Meanwhile, when it is determined that the position is inside the first region R1 (YES), the touch signal integration unit 170 proceeds to the processing at S205.

(Step S205) The touch signal integration unit 170 determines whether new “Tip=1” (that is, a new touch operation) has been detected. When it is determined that new “Tip=1” has been detected (YES), the touch signal integration unit 170 proceeds to the processing at step S209. Meanwhile, when it is determined that new “Tip=1” has not been detected (NO), the touch signal integration unit 170 proceeds to the processing at step S207.

(Step S207) Following the result of detection, the touch signal integration unit 170 outputs a touch signal containing the touch ID and operation position information associated with the detected “Tip=1” to the main system 140. That is, the touch signal integration unit 170 notifies the main system 140 of a touch signal indicating the end of the touch operation (for example, the finger is removed).

(Step S209) Based on the touch ID and operation position information associated with the newly detected “Tip=1”, the touch signal integration unit 170 determines whether the position relevant to the detected “Tip=1” is inside the second region R2. When it is determined that the position is outside the second region R2 (NO), the touch signal integration unit 170 proceeds to the processing at step S211. Meanwhile, when it is determined that the position is inside the second region R2 (YES), the touch signal integration unit 170 proceeds to the processing at step S213.

(Step S211) Following the result of detection, the touch signal integration unit 170 outputs a touch signal containing the touch ID and operation position information associated with the original “Tip=1” and a touch signal containing the touch ID and operation position information associated with the new “Tip=1” to the main system 140. That is, the touch signal integration unit 170 determines that the touch signal indicating the end of the touch operation (for example, the finger is removed) and the touch signal indicating a new touch operation are touch signals indicating different touch operations, and notifies the main system 140 of the respective touch signals. In the above, in the case where the touch ID associated with the new “Tip=1” is the same touch ID as that which is associated with the original “Tip=0”, the touch signal integration unit 170 converts the former into a different touch ID, and outputs the resultant touch ID as a touch signal indicating a different touch operation.

(Step S213) The touch signal integration unit 170 does not output a touch signal containing the touch ID and operation position information associated with the new “Tip=1”, and outputs only a touch signal containing the touch ID and operation position information associated with the original (the movement start) “Tip=1” to the main system 140, following the result of detection. That is, the touch signal integration unit 170 determines that the touch signal relevant to the original (the movement start) “Tip=1” and the touch signal relevant to the new “Tip=1” are touch signals indicating the same touch operation (that is, a drag operation), and integrates the touch signal relevant to the new “Tip=1” into the touch signal relevant to the original (the movement start) “Tip=1” (that is, the touch signal relevant to the new “Tip=1” is not outputted).

As described above, in the case where the new second touch operation relative to the touch panel B 16 is detected when the position where the first touch operation relative to the touch panel A 15 is detected is inside the first region R1 on the touch panel A 15, the information processing device 10 according to this embodiment considers the first touch operation and the second touch operation as a series of successive touch operations and integrates these operations in the case where the position where the second touch operation is detected is inside the second region R2 on the touch panel B 16. Meanwhile, when the position where the second touch operation is detected is outside the second region R2, the information processing device 10 considers the first touch operation and the second touch operation as different touch operations (that is, these operations are not integrated, but handled as different touch operations).

With the above, even when the distance between the touch panel A 15 and the touch panel B 16 is short, and both the touch panel A 15 and the touch panel B 16 are touched during a drag operation, the information processing device 10 can determine whether the touch operations relative to the respective touch panels constitute a series of successive touch operations (a drag operation) or separate touch operations. This can improve the accuracy in recognition of a drag operation across a plurality of touch panels.

### Third Embodiment

A third embodiment of the present invention will now be described.

In the first and second embodiments, touch signal integration processing in a case where the information processing device 10 includes a plurality of touch panels has been described. The touch signal integration processing described in the first and second embodiments is applicable to touch panels provided to a plurality of respective different devices.

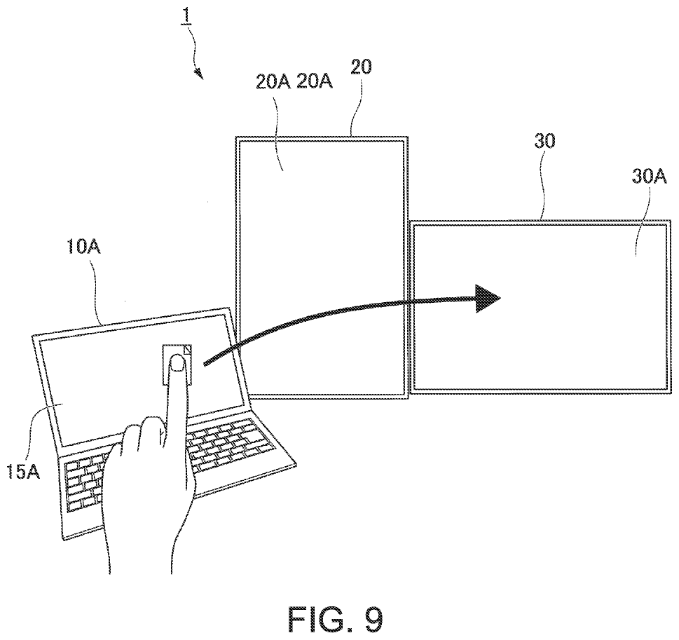

FIG. 9 illustrates an example of a structure of an information processing system 1 according to this embodiment. The information processing system 1 includes an information processing device 10A, a first display device 20, and a second display device 30. The information processing device 10A is a clamshell-type (laptop-type) personal computer (PC), and includes a touch panel 15A. The first display device 20 includes a touch panel 25. The second display device 30 includes a touch panel 35. The first display device 20 and the second display device 30 are connected to the information processing device 10A via a USB, for example, to thereby function as display units of the information processing device 10A. That is, the touch panel 15A, the touch panel 25, and the touch panel 35 can be used simultaneously as a multiple-display.

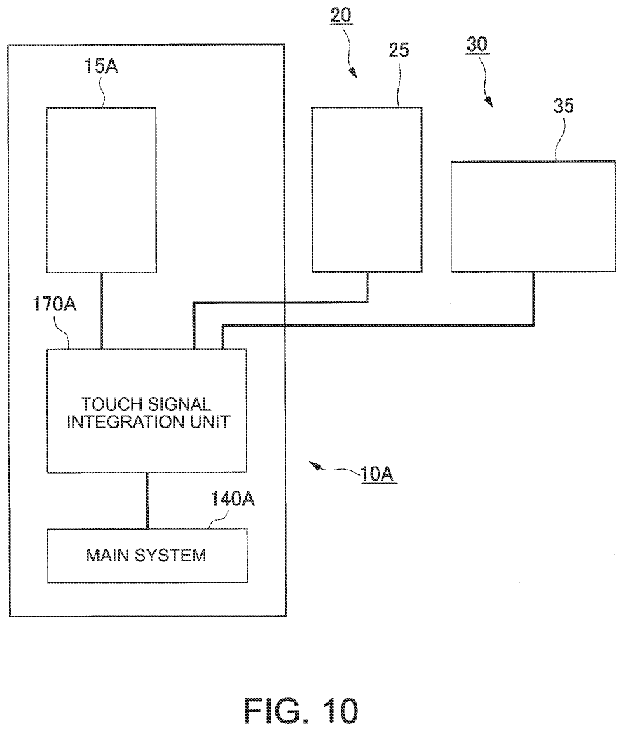

FIG. 10 is a block diagram illustrating an example of the functional structure of a touch signal integration unit according to this embodiment. The information processing device 10A includes a touch signal integration unit 170A as a structure corresponding to the touch signal integration unit 170 of the information processing device 10. The touch signal integration unit 170A obtains a result of detection in response to a touch operation relative to the touch panel 15A (a touch sensor) provided to the information processing device 10A, a result of detection in response to a touch operation relative to the touch panel 25 (a touch sensor) provided to the first display device 20, and a result of detection in response to a touch operation relative to the touch panel 35 (a touch sensor) provided to the second display device 30 from the respective devices, and integrates these results as a result of detection in response to a touch operation relative to a touch panel resulting from integration of the touch panel 15A, the touch panel 25, and the touch panel 35 into a single touch panel. As to the alignment for disposition of the touch panel 15A, the touch panel 25, and the touch panel 35, a user may be instructed to set the panels in accordance with a predetermined alignment for disposition or an alignment for disposition set by a user may be registered in advance in the information processing device 10.

Note that the touch signal integration unit 170A may be incorporated in the information processing device 10A or configured as an outside device of the information processing device 10A. For example, in the case where the touch signal integration unit 170A is configured as an outside device of the information processing device 10A, it is possible to connect a plurality of display devices as outside devices, such as the first display device 20 and the second display device 30, to an information processing device, and to integrate the results of detection in response to respective touch operations relative to the touch panels (touch sensors) of the plurality of respective display devices as a result of detection in response to a touch operation relative to a single touch panel. The information processing device in this case may be a desk-top PC or a structure that integrates only touch operations relative to touch panels of a plurality of display devices connected as outside devices.

In the above, embodiments of the present invention have been described in detail referring to the drawings. The specific structure, however, is not limited to the above-described structures, and, for example, various design modifications are possible within a range not departing from the gist of the present invention. For example, the structures described in the above embodiments may be arbitrarily combined.

Although an example of a touch operation relative to two touch panels and an example of a touch operation relative to three touch panels are described in the above embodiments, a touch signal integration processing according to this embodiment is applicable also to a touch operation relative to four or more touch panels.

Although an example of a touch operation relative to a plurality of touch-panel displays in which a touch sensor and a display unit are integrated to each other is described in the above embodiments, the touch signal integration processing according to this embodiment may be applied also to a touch operation relative to a plurality of touch panels without a display unit (for example, a touch pad).

Note that the above-described touch signal integration unit 170, 170A incorporates a computer system. A program for implementing the functions of the respective structures of the above-described touch signal integration unit 170, 170A may be recorded in a computer readable recording medium, and the program recorded in the recording medium may be read by the computer system and executed so that processing in the respective structures of the above-described touch signal integration unit 170, 170A is executed. Note that “the program recorded in the recording medium is read by the computer system and executed” here includes installing the program into the computer system. A “computer system” here includes an OS and hardware such as peripheral devices. The “computer system” may include a plurality of computer devices connected via a network, including a communication line, such as the Internet, WAN, LAN, or dedicated lines. A “computer readable recording medium” refers to portable media, such as flexible disks, photomagnetic disks, ROMs, or CD-ROMs, or storage devices, such as hard disks, built in a computer system. As described above, a recording medium recording a program may be a non-transitory recording medium, such as CD-ROMs.

Recording media also include recording media provided inside or outside and accessible from a distribution server to distribute the program. Note that a program may be divided into a plurality of sections, so that the respective sections are to be downloaded at different timings to be combined by the respective structures of the touch signal integration unit 170, 170A. The divided sections of the program may be distributed from different distribution servers. Further, a “computer readable recording medium” also includes a recording medium that holds a program for a predetermined period of time, like a volatile memory (RAM) inside a computer system that makes a server or a client when the program is sent via a network. In addition, the program may be a program that implements a part of the above-described functions. Also, the program may be a so-called differential file (a differential program), that can implement the above-described functions through combination of a program already recorded in a computer system.

Some or all of the functions included in the touch signal integration unit 170, 170A in the above-described embodiments may be implemented as an integrated circuit, such as large scale integration (LSI). The respective functions may be individually implemented as a processor, or some or all of the functions may be integrated as a processor. A method for implementing an integrated circuit is not limited to LSI, but a dedicated circuit or a general-purpose processor may be used for implementation. In the case where development in semiconductor technology produces technology for integrated circuits to replace LSI, an integrated circuit implemented with that technology may be employed.

Although an example in which the information processing device 10, 10A is a PC is described in the above-described embodiment, the information processing device 10, 10A is not limited to a PC, but may be, for example, a smart phone or a game device.

1. An information processing device, comprising:
an obtaining unit that obtains a result of detection by a first detection sensor that detects a first touch operation relative to a first panel, and obtains a result of detection by a second detection sensor that detects a second touch operation relative to a second panel; and
an integration unit that integrates, based on the results of detection obtained by the obtaining unit, the result of detection of the first touch operation relative to the first panel and the result of detection of the second touch operation relative to the second panel, as a result of detection of a touch operation relative to an integrated panel resulting from integration of the first panel and the second panel into one panel.

2. The information processing device according to claim 1, wherein, when the obtaining unit obtains a result of detection indicating that the first touch operation is no longer detected, and thereafter obtains a result of detection indicating that the second touch operation is newly detected, the integration unit determines the first touch operation and the second touch operation as a series of successive touch operations, and integrates the first touch operation and the second touch operation.

3. The information processing device according to claim 2, wherein the integration unit determines the first touch operation and the second touch operation as a series of successive touch operations, based on a period of time from when the first touch operation is no longer detected to when the second touch operation is detected.

4. The information processing device according to claim 3, wherein
the integration unit determines the first touch operation and the second touch operation as a series of successive touch operations when a period of time, from when the first touch operation is no longer detected to when the second touch operation is detected, is less than a predetermined threshold, and
the predetermined threshold is determined based on a moving speed of the first touch operation.

5. The information processing device according to claim 2, wherein the integration unit determines the first touch operation and the second touch operation as a series of successive touch operations, based on a position on the first panel when the first touch operation is no longer detected and a position on the second panel when the second touch operation is detected.

6. The information processing device according to claim 5, wherein
the integration unit determines the first touch operation and the second touch operation as a series of successive touch operations when the position of the first touch operation is no longer detected in a first region on the first panel, and when the position of the second touch operation is detected in a second region on the second panel, and
in alignment for disposition of the first panel and the second panel, the first region is at a first peripheral edge of the first panel, the first peripheral edge being at a side of the second panel, and the second region is at a second peripheral edge of the second panel, the second peripheral edge being at a side of the first panel.

7. The information processing device according to claim 1, wherein
when the second touch operation is newly detected when a position of the first touch operation is detected in a first region on the first panel, the integration unit determines the first touch operation and the second touch operation as a series of successive touch operations, and integrates the first touch operation and the second touch operation where a position of the second touch operation is detected in a second region on the second panel, and determines the first touch operation and the second touch operation as separate touch operations where the position of the second touch operation is detected outside the second region, and
in alignment for disposition of the first panel and the second panel, the first region is at the first peripheral edge of the first panel, the first peripheral edge being at a side of the second panel, and the second region is at a second peripheral edge of the second panel, the second peripheral edge being at a side of the first panel.

8. The information processing device according to claim 6, wherein the second region is a smaller region than the first region.

9. The information processing device according to claim 6, wherein the integration unit determines a position of the second region on the second panel based on a position on the first panel of the first touch operation.

10. The information processing device according to claim 6, wherein the integration unit determines a dimension of the second region on the second panel based on a moving speed of the first touch operation.

11. The information processing device according to claim 1, wherein
the obtaining unit obtains first identification information to identify the first touch operation as the result of detection by the first detection sensor, and obtains second identification information to identify the second touch operation as the result of detection by the second detection sensor, and
the integration unit converts the second identification information into the first identification information to thereby integrate the first touch operation and the second touch operation into a series of successive touch operations.

12. A control method for an information processing device, comprising the steps of:
obtaining, by an obtaining unit, a result of detection by a first detection sensor that detects a first touch operation relative to a first panel, and a result of detection by a second detection sensor that detects a second touch operation relative to a second panel; and
integrating, by an integration unit, based on the results of detection obtained by the obtaining unit, the result of detection of the first touch operation relative to the first panel and the result of detection of the second touch operation relative to the second panel, as a result of detection of a touch operation relative to an integrated panel resulting from integration of the first panel and the second panel into one panel.
